(19) United States
(12) Patent Application Publication
(10) Pub. No.: US 2007/0271975 A1
(43) Pub. Date: Nov. 29, 2007

(54) Electronic Key

(75) Inventor: Gerhard Seidel, Denkendorf (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/572,399

(22) PCT Filed: Aug. 12, 2004
(86) PCT No.: PCT/EP04/09028

§ 371 Date: Mar. 30, 2007

(30) Foreign Application Priority Data
Sep. 16, 2003 (DE) 103 42 664.7

(51) Int. Cl. E05B 19/00

(52) U.S. Cl. 70/395

(57) ABSTRACT

An electronic key for a locking system of a motor vehicle having a housing including a grip region for holding purposes and a front region, which adjoins the drip region, for inserting the key into a corresponding lock, an important feature is that a design element in the form of a separate ocmponetn is fitted to at least two lateral edge regions of the grip region.

### BACKGROUND AND SUMMARY OF THE INVENTION

The invention relates to an electronic key for a locking system of a motor vehicle.

Modern locking systems for motor vehicles are often equipped with an electronic key, for example a radio key, in order to increase convenience for the user. After the user operates the electronic key in an appropriate manner, a code, for example a radio code, is interchanged between the key and the locking system of the vehicle, so that after this code is evaluated for the appropriate output the doors or the trunk lid of the motor vehicle are unlocked or locked from a distance and other functions, for example closing of the side windows or the sliding roof, are initiated.

German Patent Document DE 199 57 046 A1 discloses an electronic lock for a locking system, in particular for a motor vehicle. In addition to the lock, the locking system includes an electronic key having a housing with a grip region for holding the key and a front region, which adjoins the grip region, for inserting the key into the lock.

German Patent Document DE 199 15 969 A1 discloses an electronic key having a plastic housing. The housing has a housing base and an associated housing cover in the form of two half-shells which are made from injection-molded plastic and are connected to one another in a sealed fashion.

The present invention provides an improved embodiment of an electronic key of the type mentioned with improved utility and ease of production.

The invention is based on the concept of fitting a design element, in the form of a separate component, to at least two lateral edge regions of a grip region of a housing of an electronic key for a locking system of a motor vehicle. The housing of the electronic key includes the abovementioned grip region for holding purposes and a front region, which adjoins said grip region, for inserting the key into an associated lock. Arranging the design elements at the lateral edge regions of the grip region provides design-related freedom and configuration options which have not been known to date, and allows, for example, the design of a key to be matched to a model specification of the motor vehicle on the basis of specially made and selected design elements.

The solution according to the invention therefore makes it possible to associate the key with a specific variant specification of the associated motor vehicle in a simple manner merely by attaching different design elements to the lateral edge regions of the electronic key. In this case, the design elements can be fitted to a basic key housing, which is standard for all of the variant specifications or model specifications, and can no longer be detached from the key housing without being destroyed once they have been factory-fitted.

In order to distinguish between the different model specifications, at least one of the design elements may be colored, for example in the same color as the paintwork of the vehicle, and/or chromium-plated. Providing the design elements in the color of the motor vehicle paint can be seen as a special design feature here, while chromium-plating the design elements, for example, gives the vehicle key a particularly classy touch.

In general, it is feasible for the design elements to be designed with differing levels of complexity depending on the scope of the specifications. Therefore, the basic variant specification may be provided, for example, with design elements which are the same color as the housing of the electronic vehicle key and therefore do not have any or only a slight design-related effect. For a mid-range model specification, design elements which are in the color of the vehicle paint may be provided for example, whereas the abovementioned chromium-plated design elements are used for the top-of-the-range model specification. As a result, it is possible to associate the electronic key with a specific model specification solely by the configuration of the design elements.

According to one preferred embodiment, at least one of the design elements may be in the form of a clasp which surrounds the respective lateral edge region. In this case, the clasps may be designed in such a way that they merge with a surface of the housing of the electronic key virtually without a transition and it is therefore impossible or virtually impossible to feel a transition region between the clasp and the housing.

At the same time or as an alternative, at least one of the design elements can fit two housing shells of the housing to one another. In this case, it is feasible for the housing to include two injection-molded plastic half-parts which in the edge region have a coupling element, for example in the form of a dovetail, in which the clasp engages and thus firmly connects the two half-parts of the housing to one another. All types of suitable clip and/or plug connections are feasible.

According to one advantageous embodiment of the invention, one of the design elements may be in the form of a battery compartment cover. In this case, the design element which is in the form of a battery compartment cover can subsequently be removed, unlike the lateral clasps, in order to gain access to the battery compartment. Forming the battery compartment cover as a design element furthermore has the advantage that the grip region of the housing is enclosed on three sides when there are additionally two lateral design clasps, and therefore a particularly distinctive design is achieved.

In accordance with a further advantageous embodiment of the solution according to the invention, the clasps may be in the form of identical parts. In contrast to conventional electronic vehicle keys which are often asymmetrical, a symmetrical design of the lateral edge regions of the grip region means the clasps can be used on either side, as a result of which only one single type of clasp has to be produced and this can be used equally at both lateral edge regions of the grip region. This halves the number of components required as compared to an asymmetrical design of the grip region and thus considerably streamlines the production process for producing the design elements.

It is expediently also possible to provide a series of an electronic key with different variants of the design elements which can be fitted as an alternative. This considerably widens the field of use and the spectrum of applications of the design elements, as a result of which the costs of producing and/or mounting the design elements can be reduced.

Further important features and advantages of the invention can be found in the subclaims, the drawings and the associated description of the figures with reference to the drawings.

It goes without saying that the abovementioned features and those still to be explained below can be used not only in the respectively specified combination but also in other combinations or alone, without departing from the scope of the present invention.

Preferred exemplary embodiments of the invention are illustrated in the drawings and are explained in greater detail in the following descriptions, with identical reference symbols relating to identical or similar or functionally identical components.

Other objects, advantages and novel features of the present invention will become apparent from the following detailed description of the invention when considered in conjunction with the accompanying drawings.

### BRIEF DESCRIPTION OF THE DRAWINGS

FIG. 1 is a plan view of an electronic key according to the invention, and

FIG. 2 is a side view of the electronic key.

### DETAILED DESCRIPTION OF THE DRAWINGS

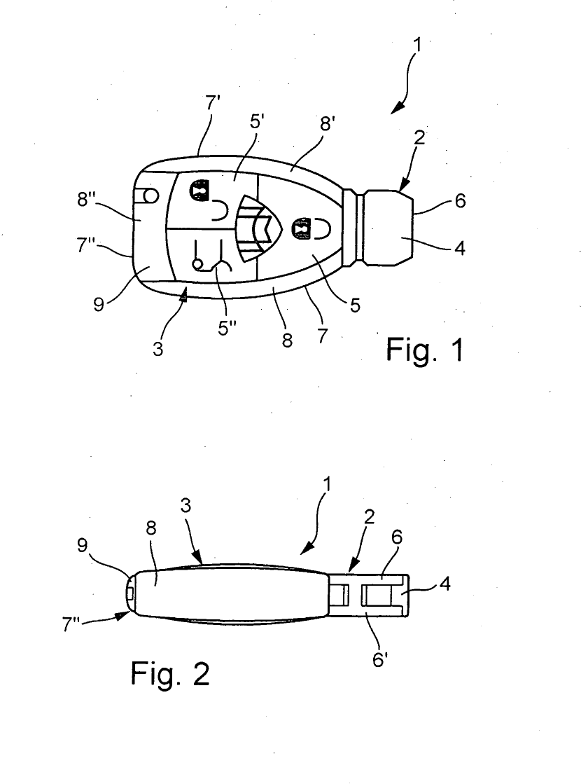

In accordance with FIG. 1, an electronic key 1 for a locking system (not illustrated) of a motor vehicle has a housing 2 which comprises a grip region 3 for holding the electronic key 1 and a front region 4 for inserting the electronic key 1 into the locking system. By way of example, a plurality of operating elements 5, 5′ and 5″ for initiating functions of the locking system by remote operator control are arranged in the grip region 3. The locking system of the motor vehicle is moved to a closed position by manually operating, that is to say pressing, the first operating element 5, whereas operating the second operating element 5′ opens the abovementioned locking system. The third operating element 5″ is designed to remotely open a trunk lid. In this case, the symbols which correspond to these functions are respectively arranged on the operating elements 5, 5′ and 5″.

According to FIG. 1, the housing 2 has a slightly wedge-like shape, as a result of which the key can be held particularly reliably and handled in an ergonomically favorable manner. Furthermore, the housing 2 is expediently produced from two housing shells 6 and 6′ which are preferably formed from a hard and impact-resistant plastic.

The grip region 3 has a total of three lateral edge regions 7, 7′ and 7″ which border said grip region in a u-shaped manner. In this case, the invention provides that a first design element 8 or a second design element 8′, which are in the form of separate components, is fitted to at least two lateral edge regions, for example a first edge region 7 and a second edge region 7′, of the grip region 3 in each case. According to FIG. 1, the design elements 8, 8′ therefore provide a lateral edge boundary for the grip region 3.

According to FIGS. 1 and 2, provision is made for at least one of the two design elements 8 or 8′ to be in the form of a clasp which surrounds the respective lateral edge region 7 or 7′. In this case, on account of the symmetrical form of the key housing 2, the clasps may expediently be in the form of identical parts, so that the number of different components that have to be produced is considerably reduced. However, an asymmetrical form of the key housing 2 is also feasible, this requiring different design elements 8 and 8′.

In accordance with FIG. 1, the clasps project beyond the housing in the longitudinal direction and accommodate a battery compartment cover 9 between the projecting regions at their end which is respectively averted from the front region 4. The battery compartment cover 9 is therefore arranged between the two design elements 8 and 8′, here the two clasps, at a third edge region 7″ of the housing 2. In this case, the battery compartment cover 9 may also be in the form of a third design element 8″ and therefore form a design-related connection between the two design elements 8 and 8′. It is also feasible for the design element 8″ which is in the form of a battery compartment cover 9 to be configured differently from the other design elements 8 and 8′, for example to be of a different color and/or to be the same color as the key housing 2.

In accordance with the variant shown in FIG. 1, the three design elements 8, 8′ and 8″ border the grip region 3 of the housing 2 in a u-shaped manner.

Provision may expediently be made for at least one design element 8, 8′ or 8″ to be captively fitted to the housing 2. This means that the respective design element 8 or 8′ is already firmly connected to the housing 2 at the factory and can no longer be subsequently removed from said housing without being destroyed. Captive fitting, for example of the two design elements 8 and 8′ which are in the form of clasps, to the housing 2 means it is possible for at least one of the design elements 8 or 8′ to fit two housing shells 6 and 6′ of the housing 2 to one another. The design elements 8 and 8′ are therefore given a double function which has both design-related and structural advantages. The two housing shells 6 and 6′ can be fitted to one another, for example, by some kind of dovetail connection or with another interlocking connection, in particular also in the manner of a plug connection, so that the housing 2 comprising the two housing shells 6 and 6′ can be assembled in a particularly simple manner by using the design elements 8, 8′ which additionally serve for fitting purposes.

Altogether, the three design elements 8, 8′ and 8″ form a smooth transition in relation to one another and in relation to the housing 2, and thus improve the overall visual appearance.

In general, provision may be made for at least one of the design elements 8, 8′ or 8″ to be colored, in particular chromium-plated. It is feasible here, for example, for the color of the individual design elements 8, 8′ or 8″ to be either matched to the color of the vehicle paint and/or to a model specification of the vehicle. In principle, the design elements 8, 8′ and 8″ may be of the same color as the housing 2 of the electronic key 1 for a standard model, whereas the design elements 8, 8′ and 8″ are the color of the vehicle for a higher model specification. Models with even higher specifications may have design elements 8, 8′ and 8″ which are chromium-plated and/or provided with special paint effects, for example. It is also feasible here to distinguish between different vehicle types and/or production models by designing the respective design elements 8, 8′ and 8″ differently. Equally, the design elements 8, 8′, 8″ of the various embodiments may also be composed of different materials (for example of metal, wood or stone), at least of a material which differs from that of the housing 2.

Furthermore, series for an electronic key 1 which comprise different variants of the design elements 8, 8′ and 8″ and can be fitted as an alternative are also conceivable. This provides, in particular, cost advantages in the production process since only one basic housing 2, which is always the same, and design elements 8, 8′ and 8″, which can be fitted to said basic housing in different ways, are provided for many variants of the electronic key 1.

The important features of the solution according to the invention can be characterized as follows:

The invention envisages in each case fitting a design element 8, 8′ or 8″ which is in the form of a separate component to at least two lateral edge regions 7, 7′ or 7″ of the grip region 3 of an electronic key 1 having a housing 2 which comprises a grip region 3 and a front region 4. In this case, the design elements 8, 8′ may be in the form of clasps and the design element 8″ may be in the form of a battery compartment cover 9, with the clasps serving in particular to fit housing parts 6, 6′ to one another and preferably being captively fitted to the housing 2.

It is possible to identify different variant specifications or model specifications and/or vehicle types in a simple manner by means of the design of the electronic key 1 by varying the color and/or material of the design elements 8, 8′ and 8″ which are associated with the respective electronic key 1. At the same time, at least one of the design elements 8 or 8′ can fit two housing shells 6 and 6′ of the housing 2 to one another and therefore have an advantageous effect in terms of structure as well as design.

1-11. (canceled)

12. An electronic key for a locking system of a motor vehicle, having a housing, said housing comprising:
a grip region for holding purposes;
a front region which adjoins said grip region, for inserting the key into a corresponding lock;
at least two lateral edge regions; and
at least one design element in the form of a separate component fitted to said at last two lateral edge regions of the grip region.

13. The electronic key as claimed in claim 12, wherein said at least one of the design element is in the form of a clasp which surrounds respective ones of said two lateral edge regions.

14. The electronic key as claimed in claim 12, wherein one of the at least one design elements is in the form of a battery compartment cover.

15. The electronic key as claimed in claim 14, wherein the battery compartment cover is arranged between two of said design elements in the edge region of the housing.

16. The electronic key as claimed in claim 15, wherein clasps project beyond the housing in a longitudinal direction and the battery compartment cover is arranged between projecting regions of the clasps.

17. The electronic key as claimed in claim 13, wherein the clasps are in the form of identical parts.

18. The electronic key as claimed in claim 12, wherein at least one of the design elements has a color other than a color of the housing and is chromium-plated and is made from a material other than that of the housing.

19. The electronic key as claimed in claim 12, wherein at least one of the design elements fits two housing shells of the housing to one another.

20. The electronic key as claimed in claim 12, wherein three design elements are provided and border the grip region in a U-shaped manner.

21. The electronic key as claimed in claim 12, wherein at least one design element is captively fitted to the housing.

22. A series of a plurality of electronic keys, each of said keys constructed as claimed in claim 12, wherein the series comprises different variants of said design elements which are fitted to the housing.

23. The electronic key according to claim 18, wherein the color of the at least one design element is a color of a vehicle for which said key is made.

24. The electronic key according to claim 18, wherein said design element is metal or wood or stone.

25. The electronic key as claimed in claim 13, wherein one of the at least one design elements is in the form of a battery compartment cover.

26. The electronic key as claimed in claim 13, wherein three design elements are provided and border the grip region in a U-shaped manner.

27. The electronic key as claimed in claim 13, wherein at least one design element is captively fitted to the housing.

28. The electronic key as claimed in claim 13, wherein at least one of the design elements fits two housing shells of the housing to one another.

29. The electronic key as claimed in claim 16, wherein the clasps are in the form of identical parts.
